(19) United States
(12) Patent Application Publication
(10) Pub. No.: US 2026/0291846 A1
(43) Pub. Date: Sep. 24, 2026

(54) METHODS AND APPARATUS FOR PERFORMANCE MEASUREMENT FUNCTION PROTOCOL PROCEDURE FOR DUAL STACK ADDRESS SESSION TYPE IN MOBILE COMMUNICATIONS

(71) Applicant: MEDIATEK INC., Hsinchu City (TW)

(72) Inventors: Yu-Hsin LIN, Hsinchu City (TW); Tze Jie TAN, Hsinchu City (TW); Hsin-Jun TANG, Hsinchu City (TW); Yuan-Chieh LIN, Hsinchu City (TW)

(73) Assignee: MEDIATEK INC., Hsinchu City (TW)

(21) Appl. No.: 19/473,792

(22) PCT Filed: Nov. 4, 2024
(86) PCT No.: PCT/CN2024/129556

§ 371 Date: Oct. 8, 2025

Related U.S. Application Data
(60) Provisional application No. 63/596,331, filed on Nov. 6, 2023.

(51) Int. Cl. H04L 43/50

(52) U.S. Cl. CPC H04L 43/50

(57) ABSTRACT

Various solutions for performance measurement function protocol (PMFP) procedure for dual stack address session type with respect to user equipment (UE) and network apparatus in mobile communications are described. A UE may establish a data session of a dual stack address session type. The UE may perform a first PMFP procedure for a first address associated with the dual stack address session type. The UE may perform a second PMFP procedure for a second address associated with the dual stack address session type. At least one of the first and the second PMFP procedures is performed immediately after the data session is established. So that the network apparatus may discover the ports corresponding different IP addresses associated with the data session of the dual stack address session type.

### CROSS REFERENCE TO RELATED PATENT APPLICATION(S)

The present disclosure is part of a non-provisional application claiming the priority benefit of U.S. Patent Application No. 63/596,331, filed 6 Nov. 2023, the content of which herein being incorporated by reference in its entirety.

### TECHNICAL FIELD

The present disclosure is generally related to mobile communications and, more particularly, to performance measurement function protocol (PMFP) procedure for dual stack address session type with respect to user equipment and network apparatus in mobile communications.

### BACKGROUND

Unless otherwise indicated herein, approaches described in this section are not prior art to the claims listed below and are not admitted as prior art by inclusion in this section.

Access Traffic Steering, Switching and Splitting (ATSSS) is a feature in the 3rd generation partnership project (3GPP) standards, which enables traffic steering across multiple accesses, including a 3GPP access (e.g., fifth generation (5G) cellular network) and a non-3GPP access (e.g., WiFi network). The ATSSS capable user equipment (UE) may perform the procedures of access performance measurements on the user plane of a multi-access protocol data unit (MA PDU) session to decide how to distribute traffic over 3GPP access and non-3GPP access. If an MA PDU session established by the UE is of the dual stack address session type, the UE has two internet protocol (IP) addresses, and each IP address corresponds to a user datagram protocol (UDP) port of the UE. Under this circumstance, to ensure the successful execution of network-initiated procedures, there is a need to provide effective schemes for the network to identify the UDP port associated with each IP address type.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to performance measurement function protocol (PMFP) procedure for dual stack address session type with respect to user equipment (UE) and network apparatus in mobile communications.

In one aspect, a method may involve an apparatus establishing a data session of a dual stack address session type. The method may also involve the apparatus performing a first PMFP procedure for a first address associated with the dual stack address session type. The method may further involve the apparatus performing a second PMFP procedure for a second address associated with the dual stack address session type.

In one aspect, an apparatus may comprise a transceiver which, during operation, wirelessly communicates with a network node. The apparatus may also comprise a processor communicatively coupled to the transceiver. The processor, during operation, may perform operations comprising establishing a data session of a dual stack address session type via the transceiver. The processor may also perform operations comprising performing a first PMFP procedure for a first address associated with the dual stack address session type. The processor may further perform operations comprising performing a second PMFP procedure for a second address associated with the dual stack address session type.

In another aspect, a method may involve a network node discovering a first port of a UE based on a first PMFP procedure performed by the UE. The method may also involve the network node discovering a second port of the UE based on a second PMFP procedure performed by the UE. In which, the first port corresponds to a first address associated with a data session established by the UE, and the second port corresponds to a second address associated with the data session established by the UE. The data session is of a dual stack address session type.

It is noteworthy that, although description provided herein may be in the context of certain radio access technologies, networks and network topologies such as LTE, LTE-Advanced, LTE-Advanced Pro, 5G, NR, 5G-Advanced, Internet-of-Things (IoT), Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario of a network-initiated procedure in accordance with implementations of the present disclosure.

FIG. 3 is a block diagram of an example communication system in accordance with an implementation of the present disclosure.

FIG. 4 is a flowchart of an example process in accordance with an implementation of the present disclosure.

FIG. 5 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to performance measurement function protocol (PMFP) procedure for dual stack address session type in mobile communications, so that the network-initiated procedures can be performed successfully via a data session of the dual stack address session type. According to the present disclosure, a number of possible solutions may be implemented separately or jointly. That is, although these possible solutions may be described below separately, two or more of these possible solutions may be implemented in one combination or another.

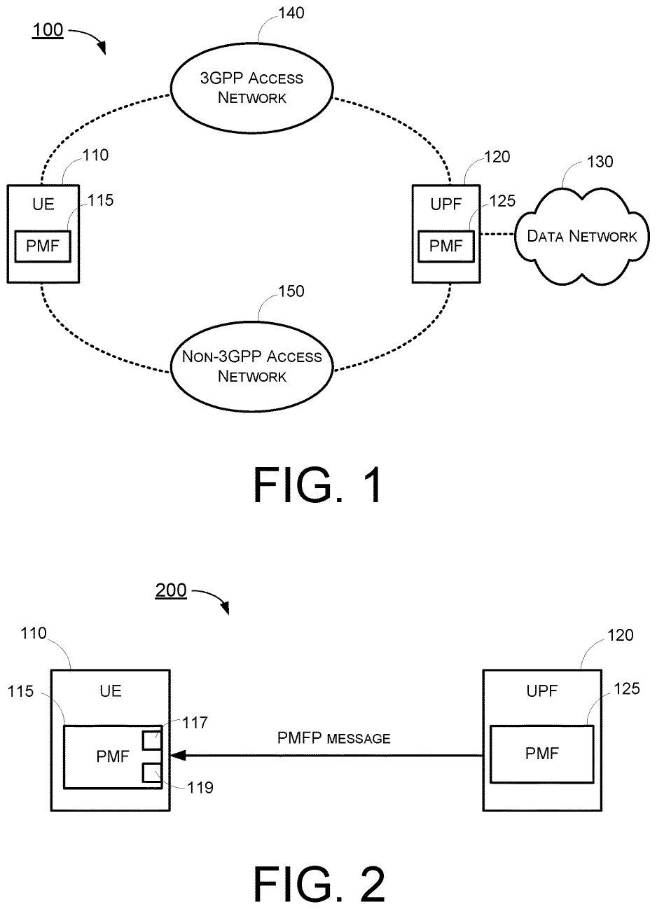

FIG. 1 is a diagram depicting an example scenario of a communication environment in which various solutions and schemes in accordance with the present disclosure may be implemented. In scenario 100, Access Traffic Steering, Switching and Splitting (ATSSS) functionalities can be supported by a UE 110 and a user plane function (UPF) 120. The ATSSS functionalities enable a multi-access protocol data unit (MA PDU) connectivity service, which can exchange PDUs between the UE 110 and a data network 130 by simultaneously using a 3rd generation partnership project (3GPP) access network 140 and a non-3GPP access network 150. The MA PDU connectivity service is realized by establishing an MA PDU session. That is, a PDU session that can have user-plane resources on both of the 3GPP access network 140 and the non-3GPP access network 150. In one embodiment, the 3GPP access network 140 may comprise one or more base stations (e.g., gNBs/eNBs) providing radio access for the UE 110 via various 3GPP radio access technologies (RATs) including but not limited to 6G, 5G, 4G, and 3G/2G, where the non-3GPP access network 150 may comprise access points (APs) providing radio access for UE 110 via non-3GPP RAT, such as WiFi.

In one embodiment, the PMFP procedures are performed between a performance measurement function (PMF) 115 in the UE 110 and a PMF 125 in the UPF 120 to measure the performance between the PMFs 115 and 125. Different PMFP procedures are carried out between the UE 110 and the UPF 120 through the transmission of distinct PMFP messages. The PMFP messages are transmitted over an access of the MA PDU session, which may be internet protocol (IP)-based PDU session type or Ethernet PDU session type. The IP-based PDU session type comprises an IPV4 PDU session type, an IPV6 PDU session type, or a dual stack address session type (e.g., an IPv4v6 PDU session type).

In an event that the MA PDU session established by the UE 110 is of the IPv4v6 PDU session type, two different IP addresses are obtained for the MA PDU session, one is an IPV4 address and the other is an IPv6 address. In order to enable the UPF 120 to discover the port and/or IP address information of the established MA PDU session, the UE 110 may perform a specific PMFP procedure over an access for each IP address in response to the MA PDU session is established. More specifically, the UE 110 may perform the specific PMFP procedure over an access for each IP address immediately after the MA PDU session is established. That is, the UE 110 may perform the specific PMFP procedure twice in an event that the MA PDU session is of the IPv4v6 PDU session type or other dual stack address session type. The specific PMFP procedures performed by the UE 110 may be an access availability or unavailability report procedure to inform the UPF 120 about availability or unavailability of an access of the MA PDU session.

In one embodiment, the UE 110 may perform a first PMFP procedure for the IPv4 address and a second PMFP procedure for the IPv6 address immediately after the MA PDU session of the IPv4v6 PDU session type is established. The first PMFP procedure may be an access availability or unavailability report procedure over an access for the IPv4 address and the second PMFP procedure may be an access availability or unavailability report procedure over an access for the IPv6 address. As shown in scenario 200 of FIG. 2, in this embodiment, after performing the first and second PMFP procedures by the UE 110, the UPF 120 may discover the user datagram protocol (UDP) port 117 of the PMF 115 corresponding to the IPv4 address based on the first PMFP procedure and the UDP port 119 of the PMF 115 corresponding to the IPv6 address based on the second PMFP procedure.

Alternatively, the UE 110 may perform a first PMFP procedure for the IPV6 address and a second PMFP procedure for the IPv4 address immediately after the MA PDU session of the IPv4v6 PDU session type is established. In this embodiment, the first PMFP procedure may be an access availability or unavailability report procedure over an access for the IPV6 address and the second PMFP procedure may be an access availability or unavailability report procedure over an access for the IPv4 address. So that the UPF 120 may discover the UDP 119 port of the PMF 115 corresponding to the IPV6 address based on the first PMFP procedure and the UDP port 117 of the PMF 115 corresponding to the IPv4 address based on the second PMFP procedure.

Therefore, the UPF 120 may perform the network-initiated PMFP procedures successfully. For example, to perform a network-initiated packet loss rate (PLR) measurement procedure, the UPF 120 may encode a PMFP message such as a PMFP PLR count request message into a UDP/IPv4 packet and transmit the UDP/IPv4 packet over an access of the MA PDU session of IPv4v6 PDU session type using the UDP port 117 as the destination port. Also, the UPF 120 may encode the PMFP PLR count request message into a UDP/IPv6 packet and transmit the UDP/IPv6 packet over an access of the MA PDU session of IPv4v6 PDU session type using the UDP port 119 as the destination port.

### Illustrative Implementations

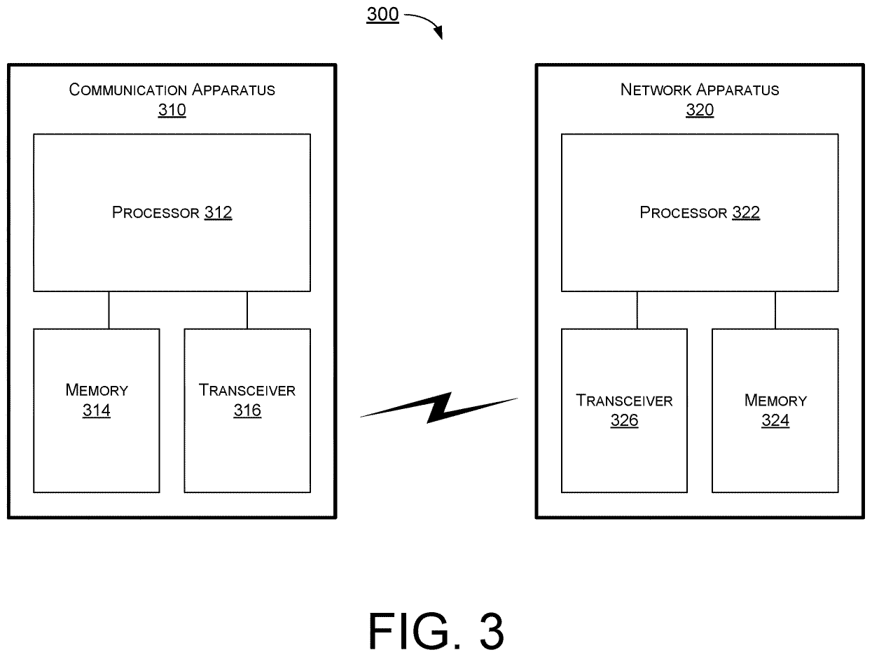

FIG. 3 illustrates an example communication system 300 having at least an example communication apparatus 310 and an example network apparatus 320 in accordance with an implementation of the present disclosure. Each of the communication apparatus 310 and network apparatus 320 may perform various functions to implement schemes, techniques, processes and methods described herein pertaining to PMFP procedure for dual stack address session type in mobile communications, including scenarios/schemes described above as well as process 400 and process 500 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a network entity supporting one or a combination of network functions (NFs). The NFs comprise, but not limited to, access and mobility management function (AMF), session management function (SMF), unified data management (UDM), and user plane function (UPF). Alternatively, network apparatus 320 may be a base station and/or a UPF. Network apparatus 320 may include at least some of those components shown in FIG. 3 such as a processor 322, for example. Processor 322 may further include protocol stacks and a set of control functional modules and circuit. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of the processor 312 and processor 322 may be implemented in the form of one or more single-core processors, one or more multi-core processors, or one or more CISC processors. That is, even though a singular term “a processor” is used herein to refer to processor 312 and processor 322, each of the processor 312 and processor 322 may include multiple processors in some implementations and a single processor in other implementations in accordance with the present disclosure. In another aspect, each of the processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 312 and processor 322 is a special-purpose machine specifically designed, arranged and configured to perform specific tasks in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein.

In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively.

For illustrative purposes and without limitation, descriptions of capabilities of the communication apparatus 310 and network apparatus 320 are provided below with process 400 and process 500. In which, communication apparatus 310 is implemented in or as a communication apparatus or a UE, and network apparatus 320 is implemented in or as a network node of a communication network (e.g., a UPF).

### Illustrative Processes

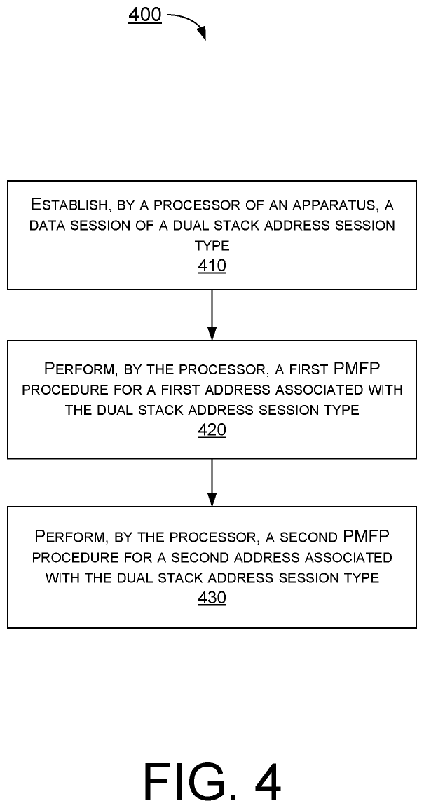

FIG. 4 illustrates an example process 400 in accordance with an implementation of the present disclosure. Process 400 may be an example implementation of above scenarios/schemes, whether partially or completely, with respect to PMFP procedure for dual stack address session type in mobile communications. Process 400 may represent an aspect of implementation of features of communication apparatus 310. Process 400 may include one or more operations, actions, or functions as illustrated by one or more of blocks 410, 420, and 430. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by communication apparatus 310 or any suitable UE (e.g., the UE 110) or machine type devices. Solely for illustrative purposes and without limitation, process 400 is described below in the context of communication apparatus 310 as a UE. Process 400 may begin at block 410.

At block 410, process 400 may involve processor 312 of communication apparatus 310 establishing a data session of a dual stack address session type. The data session is established via transceiver 316. Process 400 may proceed from block 410 to block 420.

At block 420, process 400 may involve processor 312 performing a first PMFP procedure for a first address. The first address is associated with the dual stack address session type. Process 400 may proceed from block 420 to block 430.

At block 430, process 400 may involve processor 312 performing a second PMFP procedure for a second address, in which the second address is associated with the dual stack address session type.

In some implementations, the data session may be an MA PDU session.

In some implementations, the dual stack address session type may be an IPv4v6 PDU session type.

In some implementations, the first address may be an IPv4 address, and the second address may be an IPV6 address.

In some implementations, the first PMFP procedure comprises an access availability or unavailability report procedure over an access for the IPv4 address, and the second PMFP procedure comprises an access availability or unavailability report procedure over an access for the IPv6 address.

In some implementations, the first address may be an IPV6 address, and the second address may be an IPv4 address.

In some implementations, the first PMFP procedure comprises an access availability or unavailability report procedure over an access for the IPV6 address, and the second PMFP procedure comprises an access availability or unavailability report procedure over an access for the IPv4 address.

In some implementations, at least one of the first PMFP procedure and the second PMFP procedure comprises an access availability or unavailability report procedure to inform a network node (e.g., the UPF 120 or network apparatus 320) about availability or unavailability of an access of the data session.

In some implementations, at least one of the first PMFP procedure and the second PMFP procedure is performed in response to the data session is established. In one example, both of the first and second PMFP procedures are performed immediately after the data session is established. Alternatively, one of the first and second PMFP procedures is performed immediately after the data session is established, while the other follows shortly thereafter. That is, the first and second PMFP procedures are performed sequentially, with one initiating immediately upon data session establishment.

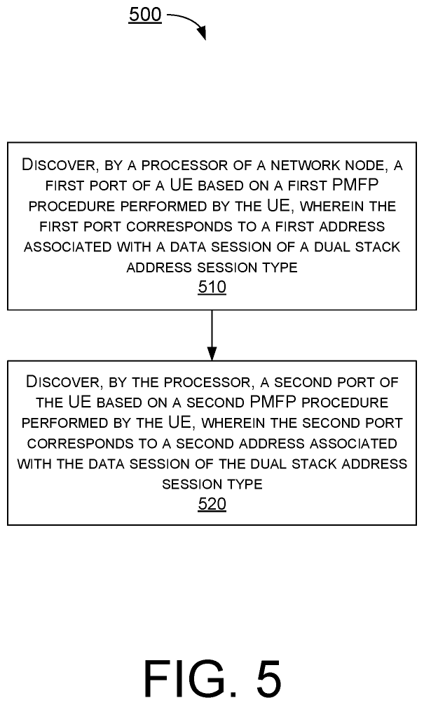

FIG. 5 illustrates another example process 500 in accordance with an implementation of the present disclosure. Process 500 may be an example implementation of above scenarios/schemes, whether partially or completely, with respect to PMFP procedure for dual stack address session type in mobile communications. Process 500 may represent an aspect of implementation of features of network apparatus 320 or any suitable network node (e.g., the UPF 120). Process 500 may include one or more operations, actions, or functions as illustrated by one or more of blocks 510, and 520. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may begin at block 510.

At block 510, process 500 may involve processor 322 of network apparatus 320 discovering a first port of a UE (e.g., communication apparatus 310) based on a first PMFP procedure performed by the UE. The first port corresponds to a first address associated with a data session of a dual stack address session type. The data session is established by the UE. Process 500 may proceed from block 510 to block 520.

At block 520, process 500 may involve processor 322 discovering a second port of the UE based on a second PMFP procedure performed by the UE. The second port corresponds to a second address associated with the data session of the dual stack address session type.

In some implementations, the data session may be an MA PDU session.

In some implementations, the dual stack address session type may be an IPv4v6 PDU session type. The first address may be an IPv4 address and the second address may be an IPV6 address. The first PMFP procedure comprises an access availability or unavailability report procedure over an access for the IPv4 address and the second PMFP procedure comprises an access availability or unavailability report procedure over an access for the IPv6 address.

In some implementations, the dual stack address session type may be an IPv4v6 PDU session type. The first address may be an IPV6 address and the second address may be an IPv4 address. The first PMFP procedure comprises an access availability or unavailability report procedure over an access for the IPV6 address and the second PMFP procedure comprises an access availability or unavailability report procedure over an access for the IPv4 address Additional Notes The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
establishing, by a processor of an apparatus, a data session of a dual stack address session type;
performing, by the processor, a first performance measurement function protocol (PMFP) procedure for a first address associated with the dual stack address session type; and
performing, by the processor, a second PMFP procedure for a second address associated with the dual stack address session type.

2. The method of claim 1, wherein the data session comprises a multi-access protocol data unit (MA PDU) session.

3. The method of claim 1, wherein the dual stack address session type comprises an IPv4v6 PDU session type.

4. The method of claim 1, wherein the first address comprises an IPv4 address and the second address comprises an IPV6 address.

5. The method of claim 4, wherein the first PMFP procedure comprises an access availability or unavailability report procedure over an access for the IPv4 address and the second PMFP procedure comprises an access availability or unavailability report procedure over an access for the IPV6 address.

6. The method of claim 1, wherein the first address comprises an IPV6 address and the second address comprises an IPV4 address.

7. The method of claim 6, wherein the first PMFP procedure comprises an access availability or unavailability report procedure over an access for the IPV6 address and the second PMFP procedure comprises an access availability or unavailability report procedure over an access for the IPv4 address.

8. The method of claim 1, wherein at least one of the first PMFP procedure and the second PMFP procedure comprises an access availability or unavailability report procedure to inform a network node about availability or unavailability of an access of the data session.

9. The method of claim 1, wherein at least one of the first PMFP procedure and the second PMFP procedure is performed in response to the data session is established.

10. An apparatus, comprising:
a transceiver which, during operation, communicates wirelessly; and
a processor communicatively coupled to the transceiver such that, during operation, the processor performs operations comprising:
establishing, via the transceiver, a data session of a dual stack address session type;
performing a first PMFP procedure for a first address associated with the dual stack address session type; and
performing a second PMFP procedure for a second address associated with the dual stack address session type.

11. The apparatus of claim 10, wherein the dual stack address session type comprises an IPv4v6 PDU session type.

12. The apparatus of claim 10, wherein the first address comprises an IPv4 address and the second address comprises an IPV6 address.

13. The apparatus of claim 12, wherein the first PMFP procedure comprises an access availability or unavailability report procedure over an access for the IPv4 address and the second PMFP procedure comprises an access availability or unavailability report procedure over an access for the IPv6 address.

14. The apparatus of claim 10, wherein the first address comprises an IPv6 address and the second address comprises an IPV4 address.

15. The apparatus of claim 14, wherein the first PMFP procedure comprises an access availability or unavailability report procedure over an access for the IPv6 address and the second PMFP procedure comprises an access availability or unavailability report procedure over an access for the IPv4 address.

16. The apparatus of claim 10, wherein at least one of the first PMFP procedure and the second PMFP procedure comprises an access availability or unavailability report procedure to inform a network node about availability or unavailability of an access of the data session.

17. The apparatus of claim 10, wherein at least one of the first PMFP procedure and the second PMFP procedure is performed in response to the data session is established.

18. A method, comprising:
discovering, by a processor of a network node, a first port of a user equipment (UE) based on a first PMFP procedure performed by the UE, wherein the first port corresponds to a first address associated with a data session of a dual stack address session type; and
discovering, by the processor, a second port of the UE based on a second PMFP procedure performed by the UE, wherein the second port corresponds to a second address associated with the data session of the dual stack address session type.

19. The method of claim 18, wherein:
the dual stack address session type comprises an IPv4v6 PDU session type;
the first address comprises an IPv4 address and the second address comprises an IPV6 address; and
the first PMFP procedure comprises an access availability or unavailability report procedure over an access for the IPv4 address and the second PMFP procedure comprises an access availability or unavailability report procedure over an access for the IPv6 address.

20. The method of claim 18, wherein:
the dual stack address session type comprises an IPv4v6 PDU session type;
the first address comprises an IPV6 address and the second address comprises an IPV4 address; and
the first PMFP procedure comprises an access availability or unavailability report procedure over an access for the IPV6 address and the second PMFP procedure comprises an access availability or unavailability report procedure over an access for the IPv4 address.
